(19) United States
(12) Patent Application Publication
(10) Pub. No.: US 2010/0071022 A1
(43) Pub. Date: Mar. 18, 2010

(54) EVENT DISPLAY CONTROLLED BYINTERACTIVE DIGITAL TV APPLICATION

(76) Inventor: Fabien Guillorit, Dover, MA (US)

Correspondence Address: HEAD, JOHNSON & KACHIGIAN, 228 W 17TH PLACE, TULSA, OK, 74119, US

(21) Appl. No.: 11/718,399

(22) PCT Filed: Nov. 1, 2005
(86) PCT No.: PCT/IB05/53561

§ 371 Date: Apr. 23, 2009

Related U.S. Application Data
(60) Provisional application No. 60/624,890, filed on Nov. 4, 2004.

(51) Int. Cl. H04N 7/16

(52) U.S. Cl. 725/141; 725/135

(57) ABSTRACT

An event display device or panel (108) wirelessly receives, for display in real time (220), content that a television or set-top box has parsed (210) from a program of interest embodied in digital broadcast signal (112). In another embodiment, notification is formed by parsed out content that it represents a current event or current development of the program (212), and the notification is wirelessly transmitted for display on the device.

The present invention relates to notifying of an event within a current television program and, in particular, wirelessly transmitting notification to a display.

People often want to keep track of current developments in a television program during a time period in which they cannot view the program. For example, if relatives or friends come to visit, although the host may feel reluctant to turn on the television, he or she may want to immediately know about events as they happen in a television program of interest. There may be one or more sporting events presently being broadcasted. Or the current weather in a specific locality, current stock prices, or news headlines may be of interest.

It would be desirable to have displays dedicated to providing this information, without having to turn on the television. Preferably, the displays arc portable and configured for wireless reception. The signal can be transmitted from the television or set-top box. Accordingly, the functionality of the displays is reduced, keeping the displays simple, lightweight and easily maneuverable into a desired viewing orientation. Each display may be configured or set for presenting one or more respective applications. One display, for example, could be devoted to sports or a specific sport. The shape of the image on the display, or of the display itself, is preferably arranged to facilitate the viewer's immediate recognition of the corresponding application. Thus, for example, a display devoted to updates or current events of soccer games can be shaped like a soccer ball. In some embodiments, the wireless receiving device is not limited to display of information. Instead, the device can, for instance, present audio or still pictures derived from the broadcast signal. One or more of the wireless receiving devices or displays may be placed in rooms throughout the user's premises.

Details of the invention disclosed herein shall be described with the aid of the figures listed below, wherein:

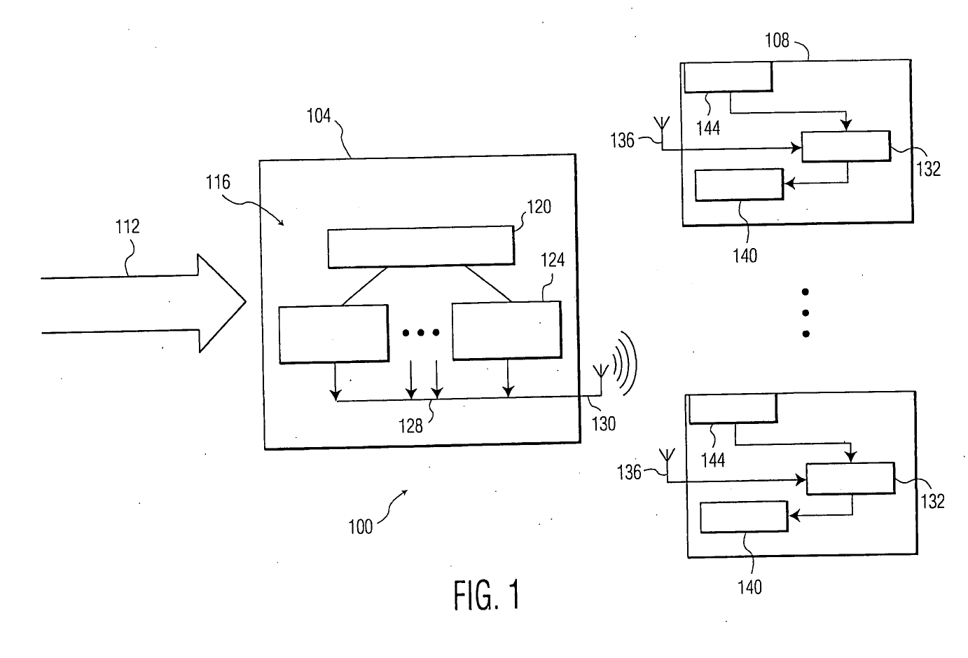

FIG. 1 is a block diagram depicting an overview of an exemplary event display system;

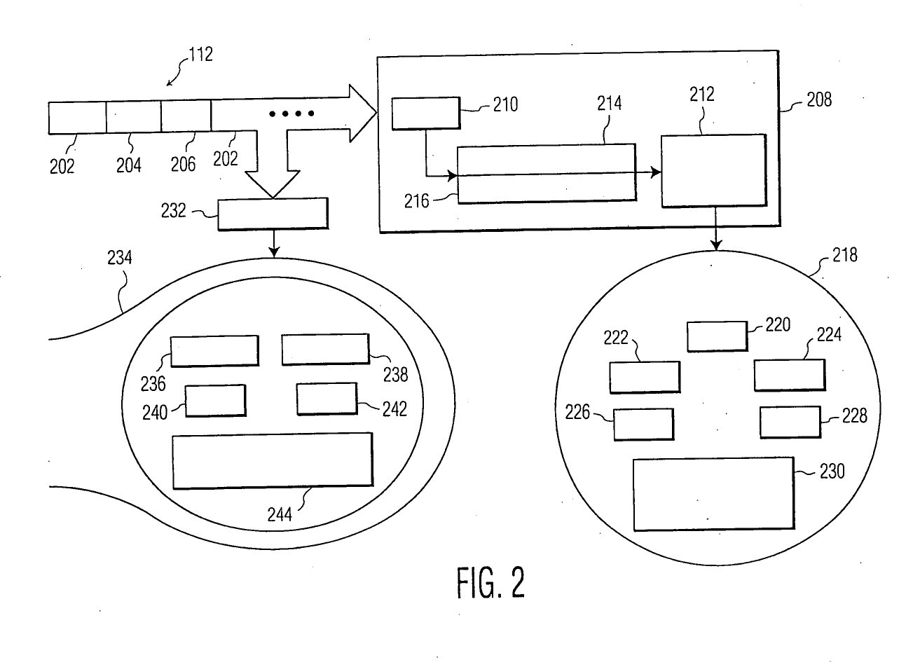

FIG. 2 is a conceptual diagram showing in more detail the digital receiver and event display devices in FIG. 1; and

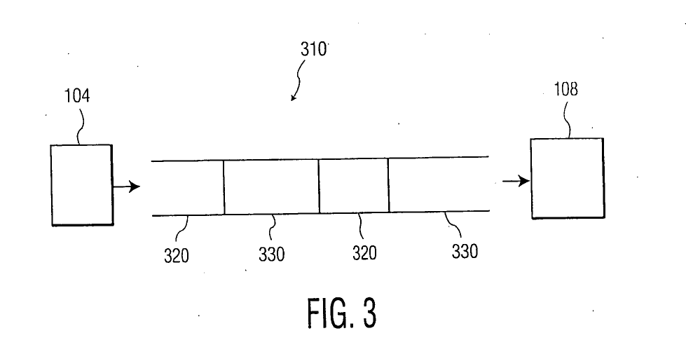

FIG. 3 is a diagram showing a possible format of the wireless transmission stream between the digital receiver and the event display devices.

FIG. 1 provides, by way of illustrative and non-limitative example, an overview of an event display system 100 according to the present invention. The event display system 100 includes a digital receiver 104 and one or more event display panels or devices 108. The digital receiver 104 is preferably a consumer electronics apparatus, such as a television or set-top box, for receiving a digital television broadcast signal 112. One example of such a signal is one for interactive digital TV, which affords the user interactive participation as through interactive games, submitting commands or queries that modify the returning content, etc.

The digital receiver 104 includes application software 116 that filters the incoming signal 112 to derive information to be displayed or otherwise presented. The digital receiver 104 and the incoming signal 112 preferably conform to a digital TV (DTV) standard, such as Multimedia Home Platform (MHP) or OpenCable Application Platform (OCAP). The application software 116 includes an application manager 120, and XLET applications 124. The application manager 120 closely monitors the lifecycles of the XLET applications 124 and can initialize, start, pause, resume and terminate any XLET application. Thus, if applications 124 for some event display devices 108 are running, for example, ticker bars of stocks, and other applications of respective devices arc capturing still pictures of local weather maps, the application manager 124 may force one or more active applications to pause or terminate so as not to overburden the system 100. Each XLET application filters one or more respective types of information to form a bit stream 128. The bit stream 128 is transmitted wirelessly from the digital receiver 104 by an antenna 130 for reception by the event display devices 108. The transmission may be radio-frequency (RF) such as under the emerging Zigbee standard. Alternatively, for example, the transmission can be infrared (IR) under the Infrared Data Association (IrDA) protocol, or it can be a Bluetooth transmission. Each of the three standards has respective upper and lower limits on its transmission range. The Zigbee upper limit is the largest of the three, extending up to 300 meters. If infrared is employed, the antenna-to-antenna configuration shown in FIG. 1 would typically be replaced by an emitter-to-pickup arrangement, requiring a line of sight between each emitter and respective pickup.

Each event display device 108 houses a display 132, and further includes an antenna 136, memory 140, and buttons or other user-input control or actuators 144. As an example, the input control may be afforded by a touch screen. The transmitted information 128 is received by the antennas 136. The display 132, which includes a processor (not shown) checks one or more fields in the stream 128 to determine whether the transmission is intended for display on that device 108. If incoming data is intended for display, it is displayed; otherwise, it is ignored or discarded. Some portion of the incoming data, preferably the displayed portion, is saved to memory 140. The user can browse or navigate the saved data by appropriately operating the buttons 144. The event display device 108 preferably operates as a slave with the digital receiver 104 as the master, in a master/slave relationship. Thus, for example, the digital receiver 104 may format data for display and control the displaying of information on the event display device 108.

The above description of the event display system 100 is not limiting. For example, the event display device 108 need not be equipped with memory 140 or buttons 144, or with means to browse data. In addition, the filtering of information in the digital receiver 104 does not require the specific application software architecture shown, and can be implemented with any combination of software and hardware, by any known and suitable means. Since the functionality and architecture of the television or set-top box 104 is well-known, details not in need of further description have been omitted. Nor are the event display devices 108 confined to the structures shown in FIG. 1.

FIG. 2 provides additional, exemplary details of functions and structures within the event display system 100. The incoming broadcast signal 112 is shown in FIG. 2 as having audio 202, video 204 and data 206 components, although the ordering of these components in FIG. 2 is merely an example. Control information (not shown) would typically be included in the signal 112. An application 208, such as an XLET application, receives the signal 112 and includes a parser 210 and a data and screen formatter 212. A tuner (not shown) initially receives the signal 112, and tunes in to a desired channel. The parser 210 filters through the channel to separate out non-audio, non-video data representing at least one current event from a program broadcasted in the signal 112. In a soccer game between teams A and B, the present score 214 may be data representative of one of the current events. The user may want to see the score each time it changes or, for example, each time the difference between the scores of the two teams exceeds a predetermined threshold. The user can select or otherwise designate the desired channel, the game, the score capture criteria and other parameters via a user interface (not shown) to the television or set-top box 104. Alternatively, or in addition, the buttons 144 and display 132 of the event display device 108 may be used for this purpose. Another example of data 216 representative of a current event from the program is that player Z is injured. The data and screen formatter 212 derives from the filtered data 214, 216 event notification for subsequent transmission to the event display device(s) 108. Thus, for example, if one of the screen fields of the device 218 is the “winning team,” the formatter 212 would derive from the game score 214 which of the two teams is winning and select that team's name for display. The formatter 212 would also place the game score 214 in the appropriate screen field(s). In a preferred embodiment, the transmission to the event display device(s) 218 is already screen-formatted.

The image presented on the event display device 218, and preferably the device itself, may be shaped and/or dimensioned to facilitate viewer recognition of the type of data displayed. The event display device 218 is shaped like a soccer ball, and displays notification of the time left in the game 220, team A 222, team B 224, the present scores 226, 228 of the two teams that make up the game score 214, and information 230 on current developments, i.e., the injury of player Z and an announcement that player X scored. In the above example of a soccer game, the game is the program of interest from which information is to be parsed for display. A distinction is hereby drawn between a program and any Electronic Programming Guide (EPG) embodied within the broadcast signal 112. An EPG is typically a schedule of programming and, as such, is incidental to the actual program content being wirelessly transmitted for display in an aspect of the present invention. In accordance with such an aspect, an audio track of a program of interest or a still picture from the program may be parsed out and presented in real time on the wireless receiving device 108.

Another XLET application 232, whose architecture (not shown) is preferably identical to that of the application 208, captures and transmits a type of a current event different from the type captured and transmitted by application 208. The latter application 208 specializes in soccer games, whereas the former application 232 specializes in tennis games. Accordingly, the respective event display device 234 is shaped like a tennis racquet. The screen fields include ones for the players 236, 238, the scores 240, 242 and information 244, here indicating that player Y has broken his or her opponent's service.

The two applications 208, 232 may execute concurrently, and generally asynchronously, according to the decisions by the application manager 120 based on system resource constraints.

A single application might assume the functions of both applications 208, 232, and assume control of “sports display.”

Moreover, any single application may drive more than one event display device 218, as when different rooms in the user's premises have the same display. FIG. 3 depicts an exemplary format 310 for the wireless transmission between the digital receiver 104 and an event display device 108. Event data 320 is interspersed with control data 330. The control data 330 may control the timing of screen field updating and/or the allocation of event data to the various screen fields. The control data 330 may also control a dynamic change in the types of screen fields and their placement on-screen. Alternatively, any or all of these control functions can be assumed by the processor in the display 132.

While there have been shown and described what are considered to be preferred embodiments of the invention, it will be understood, of course, that various modifications and changes in form or detail could be readily made without departing from the spirit of the invention. For example, the event display device 108 and set-top box can be further configured so that the buttons 144 allow communication with the broadcast provider. Thus, while viewing an educational program, a child could interactively play games involving letters and shapes. It is therefore intended that the invention not be limited to the exact forms described and illustrated, but should be constructed to cover all modifications that may fall within the scope of the appended claims.

1. A consumer-electronics event-display device (108) configured for receiving, in a wireless transmission (130) from a consumer electronics apparatus (104), notification of occurrence of at least one respective type of a current event of a program presently being broadcasted for digital television (214, 216), for displaying the received notification (218, 234), and for performing said displaying in real time and unaccompanied by any other portion of said program.

2. The event display device of claim 1, wherein the wireless transmission has a range less than 400 meters (130).

3. The event display device of claim 1, further configured for checking a wireless incoming signal for said at least one respective type of current event to determine whether occurrence of any of the at least one respective type of a current event is being notified by said signal (132).

4. The event display device of claim 1, further including a memory (140) and a user-input unit (144) and being configured to save received notifications, the saved information being viewable as a result of said displaying according to operation of the user-input unit.

5. The event display device of claim 1, configured for receiving said notification pre-formatted for said displaying (212).

6. The event display device of claim 1, wherein said displaying is configured to be controlled by a signal (330) that conveys said notification.

7. An event display apparatus comprising a plurality (218, 234) of the event display devices of claim 1, each device configured for wirelessly and correspondingly receiving notification of occurrence of its at least one respective type of a current event of a program.

8. The event display apparatus of claim 7, wherein each device is shaped and/or dimensioned (218, 234) to facilitate viewer recognition of its corresponding at least one respective type of a current event.

9. The event display apparatus of claim 7, wherein said displaying occurs from a display shaped and/or dimensioned (218, 234) to facilitate viewer recognition of its respective type of current a event.

10. The event display device of claim 7, wherein the wireless transmission has a range less than 400 meters (130).

11. A consumer electronics apparatus (104) configured for receiving a digital television broadcast signal (112) embedded into which is non-audio, non-video data (206) representing at least one current event (214) from a program broadcasted in said signal, parsing out said data (210), forming (212), from the parsed out data, notification of said event, and wirelessly transmitting (130) the formed notification for presentation in real time on a display (108).

12. The apparatus of claim 11, configured to control said display (330).

13. The apparatus of claim 12, configured as the master, said display being configured as a slave, in a master/slave implementation (330).

14. The apparatus of claim 12, wherein said display (132) is housed on an event display device (108) that said apparatus is configured to control.

15. The apparatus of claim 11, further configured so that said forming includes formatting the notification for presentation on said display (212).

16. The apparatus of claim 11, wherein at least one of said parsing and forming is executed by an application that an application manager is operable to initialize, start, pause, resume and terminate (124).

17. The apparatus of claim 16, wherein another current event is embedded in said signal, said at least one of said parsing and forming being performed for said another current event by another application (232).

18. The apparatus of claim 11, comprising at least one of a set-top box and a television (104).

19. A method for notifying, comprising the acts of:
receiving, in a wireless transmission (130) from a consumer electronics apparatus (104), notification of occurrence of at least one respective type of a current event (214, 216) of a program presently being broadcasted for digital television (112); and
displaying the received notification, said displaying being performed in real time and unaccompanied by any other portion of said program (220, 244).

20. A method for preparing to notify, said method comprising the acts of:
receiving, by a consumer electronics apparatus (104), a digital television broadcast signal (112) embedded into which is non-audio, non-video data (206) representing at least one current event (214, 216) from a program broadcasted in said signal;
parsing out said data (210);
forming (212), from the parsed out data, notification of said at least one current event; and
wirelessly transmitting (130) the formed notification for presentation in real time on a display (220, 244).

21. A computer software product for an event display device (108), said device including a medium readable by a processor (140), said product residing within the medium and containing instructions executable to perform acts including:
receiving, in a wireless transmission (130) from a consumer electronic apparatus (104), notification of occurrence of at least one respective type of a current event (214, 216) of a program presently being broadcasted for digital television (112); and
displaying the received notification, said displaying being performed in real time and unaccompanied by any other portion of said program (220, 244).

22. A computer software product for a consumer electronic apparatus (104), said apparatus including a medium readable by a processor (140), said product residing within the medium and containing instructions executable to perform acts including:
receiving, by said consumer electronic apparatus, a digital television broadcast signal (112) embedded into which is non-audio, non-video data (206) representing at least one current event (214, 216) from a program broadcasted in said signal;
parsing out said data (210);
forming (212), from the parsed out data, notification of said at least one current event; and
wirelessly transmitting (130) the formed notification for presentation in real time on a display (220, 244).

23. A consumer electronics apparatus (104) configured for receiving a digital television broadcast signal (112) having, in a portion of said signal, content from a specific program broadcasted in said signal, said content in said portion not coinciding with any electronic programming guide, if any, in said signal, parsing out said content (210), and wirelessly transmitting (130) the parsed out content for presentation in real time by a receiving device (220, 244).

24. The apparatus of claim 23, wherein said parsed out content comprises a current development in said program (244).
